(19) United States
(12) Patent Application Publication
(10) Pub. No.: US 2017/0237272 A1
(43) Pub. Date: Aug. 17, 2017

(54) PORTABLE CHARGING TRAVEL PILLOW

(71) Applicant: Alvaro Corona, Aurora, IL (US)

(72) Inventor: Alvaro Corona, Aurora, IL (US)

(21) Appl. No.: 15/043,559

(22) Filed: Feb. 13, 2016

(51) Int. Cl. H02J 7/00

(52) U.S. Cl. CPC H02J 7/0044

(57) ABSTRACT

Described is the portable, charging travel pillow having a removable portable power bank for providing the user with a comfortable place for resting the neck and head and charging the user's handheld portable mobile device. The portable, charging travel pillow provides a portable pillow body with the removable fabric cover and a removable portable power bank.

The portable, charging travel pillow is a fully-functional portable pillow body with portable charging capability via the portable power bank. device for texting or viewing handheld mobile devices while charging said handheld mobile device portably and comfortably.

### CROSS-REFERENCES TO RELATED APPLICATIONS

The present application claims priority of U.S. Provisional Application No. 62132484, dated Mar. 12, 2015, filed by same applicant.

### TECHNICAL FIELD OF THE INVENTION

The present invention relates to pillows and portable chargers, specifically to portable travel pillows. The present invention is directed to a portable travel pillows that simultaneously supports the user's head and neck while providing portable charging capabilities to the user's personal handheld mobile devices.

### BACKGROUND OF THE INVENTION

Of the estimated 6 billion people in the world, over an estimated 4 billion people have mobile phones or personal handheld mobile devices. Texting and emailing on these personal handheld mobile devices has become a dominant form of communication. Viewing the internet, emails, videos, movies and television has also become a daily function of the personal handheld mobile device user. Mobile technology has been designed for just about every application. Tablets, PDA, MP3, e-readers, media players, wireless gaming controllers, the list goes on. On average, it is estimated that Americans spend 2.7 hours per day communicating and socializing on their phones or personal handheld mobile devices and even more time looking down at their mobile devices for web searching, emails, videos, movies and television.

People of all ages are estimated to spend countless hours daily hunched over numerous types of handheld devices. While an estimated 75% of the world's population re all in constant danger and at risk of developing headaches, upper back pain, shoulder pain, neck pain and increased curvature of the spine. The frequent forward flexion is claimed to cause changes in the cervical spine, its curvature, supporting ligaments, tendons, and musculature, as well as the bony segments, commonly causing postural change.

Widespread overuse of handheld mobile technology is resulting in a harmful and dangerous physical condition on the human body. Such health condition is derived from the onset of cervical spinal degeneration resulting from the repeated stress of frequent forward head flexion while looking down at the screens of mobile devices and ‘texting’ for long periods of time. This health condition has become a world-wide health concern, affecting millions of all ages and from all walks of life. Among the chief complaints claimed to be associated with such condition are pain felt in the neck, shoulder, back, arm, fingers, hands, wrists and elbows, as well as headaches and numbness and tingling of the upper extremities.

Public transportation vehicles, such as trains, planes, automobiles or intra-city buses all require passengers to occupy their seats for extended periods of time. Passenger seating is usually arranged to efficiently pack as many people together, over the smallest area possible. Such arrangements can make long periods of time uncomfortable and tedious for passengers and travelers. Attempting to relax in such environment usually results in poor posture. This, without neck support, can result in headaches, upper back pain, shoulder pain, neck pain and increased curvature of the spine.

A large percentage of travelers resort to travel pillows to provide stable support for the neck. These pillows are ideally small, often with a foam or memory-foam core and a fabric cover.

Some are U-shaped to receive and maintain the head and neck in an upright manner. This permits the user to rest, relax and sleep in an up-right position.

Mobile consumer products such as cell phones, tablet computers, audio players, portable video players, video games and the like use rechargeable batteries. The device battery may be depleted when a device is used extensively. In an effort to address this problem, portable power banks are available that can provide additional power to recharge the battery of a device after the device's battery is depleted.

A portable power bank is a portable device that can supply USB power using stored energy in its built-in batteries. Portable power banks usually re-charge with USB power. A portable power banks specifications are ideally measured in mAh: amount of mA×time at 5V with an external 5V Type-A USB Output Only connector and an internal 5V microUSB (Micro-USB) Input Only connector for storing electric energy and then use it later to charge up a mobile device. The portable power banks mentioned are used to charge any USB-charged or USB-powered device such as mobile phones, wireless gaming controllers, cameras, GoPros, portable speakers, GPS systems, MP3 players, smartphones and tablets.

Three issues of present travel pillows are addressed by the present invention: Viewing handheld mobile devices comfortably; traveling comfortably; and not having power sources to charge the handheld mobile device while traveling or simply viewing the handheld mobile device with comfort. To overcome these issues, the present invention provides novel features such as the portable pillow body, the removable fabric cover and the portable power bank to allow users to text or view handheld mobile devices while charging said handheld mobile device portably and comfortably.

### BRIEF SUMMARY OF THE INVENTION

Accordingly, the present invention is directed to a portable, charging travel pillow comprising: A portable pillow body having a U shaped design having a removable fabric covering that is secured about said portable pillow body wherein said covering provides access to the portable pillow body, and a charging and re-chargeable portable power bank disposed at one end of the portable pillow body, said portable power bank operable to output electric energy to a portable handheld mobile device using Universal Serial Bus (USB) power as well as being able to receive electric energy via micro Universal Serial Bus (micro- USB) power. The portable pillow body further includes a housing for said portable power bank having a closure means to secure the portable power bank within said housing while allowing said portable power bank to be removed from within said portable pillow body for use as an individual portable power bank.

### BRIEF DESCRIPTION OF THE DRAWINGS

FIG. 1 illustrates the perspective view of the portable, charging travel pillow with the portable power bank disposed at one end of the pillow body;

FIG. 2 illustrates the top view of the portable, charging travel pillow with the portable bank disposed at one end of the pillow body;

FIG. 3 illustrates the bottom view of the portable, charging travel pillow with the portable bank disposed at one end of the pillow body;

FIG. 4 illustrates the front view of the portable, charging travel pillow with the portable bank disposed at one end of the pillow body; and

FIG. 5 illustrates the front view of an embodiment of the portable, charging travel pillow wherein the pillow body possesses an inflatable compartment with the portable bank disposed at one end of the pillow body.

### DETAILED DESCRIPTION OF THE INVENTION

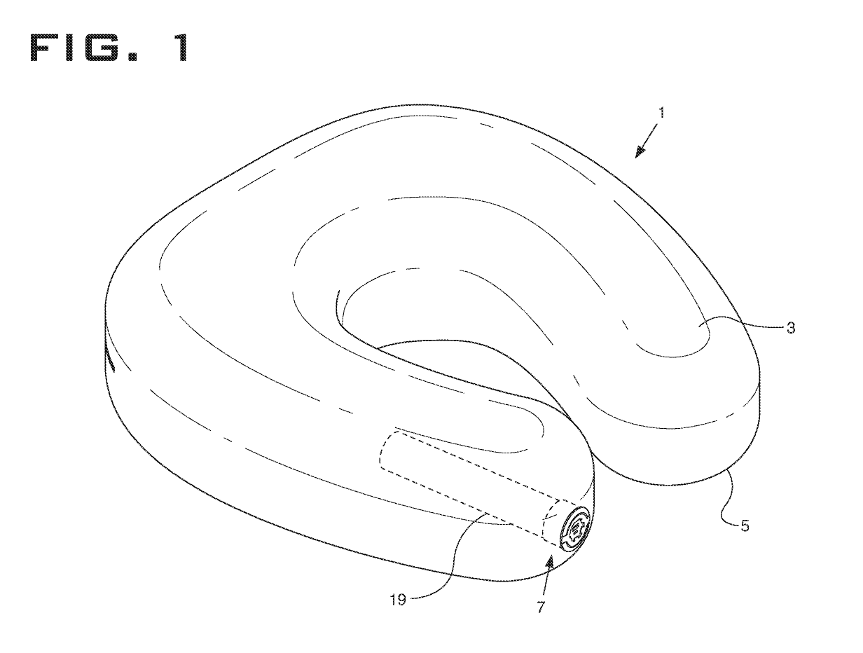

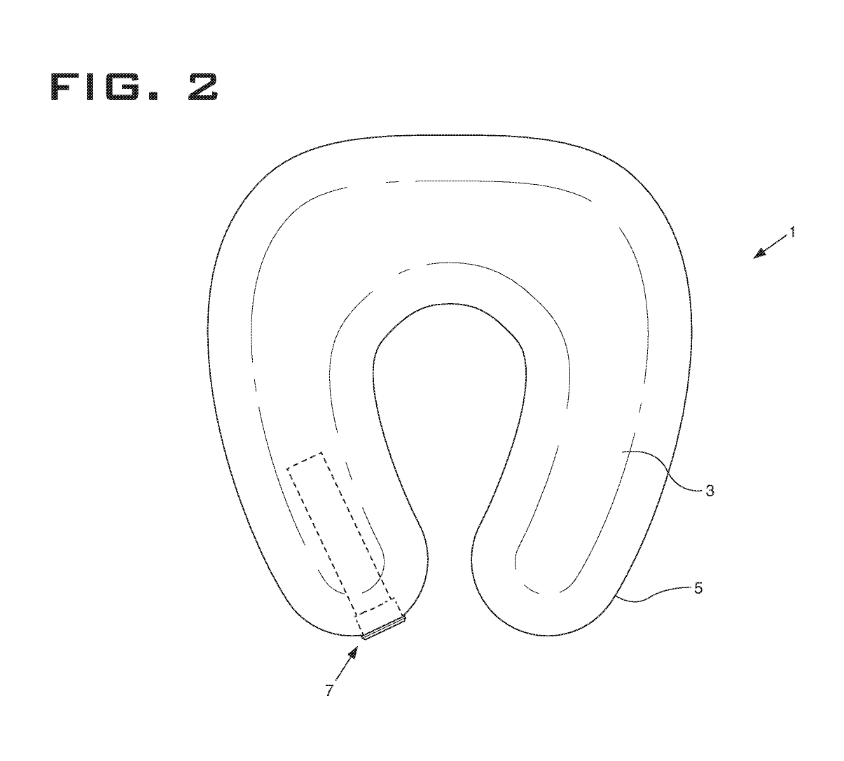

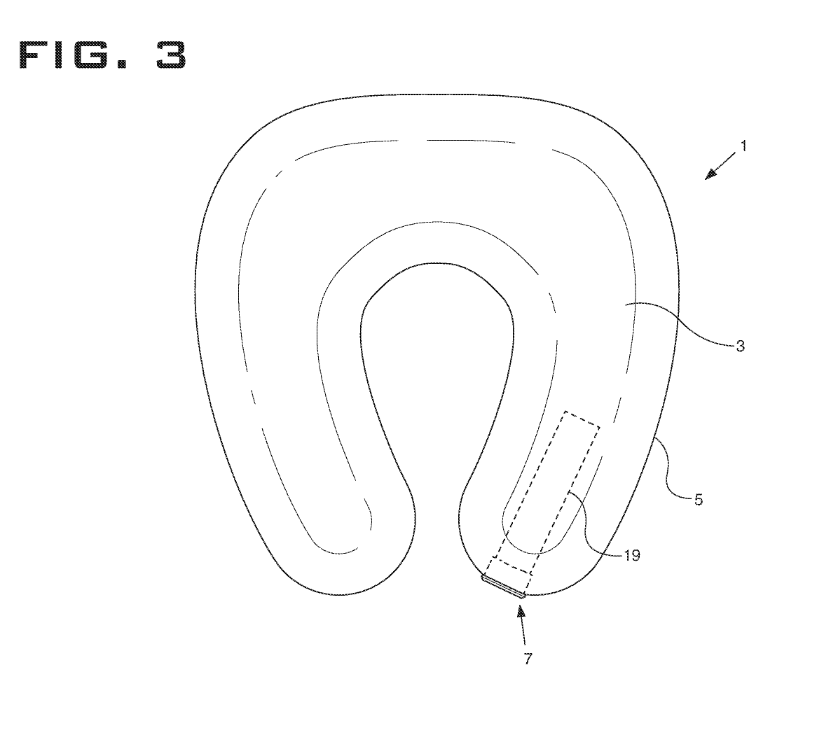

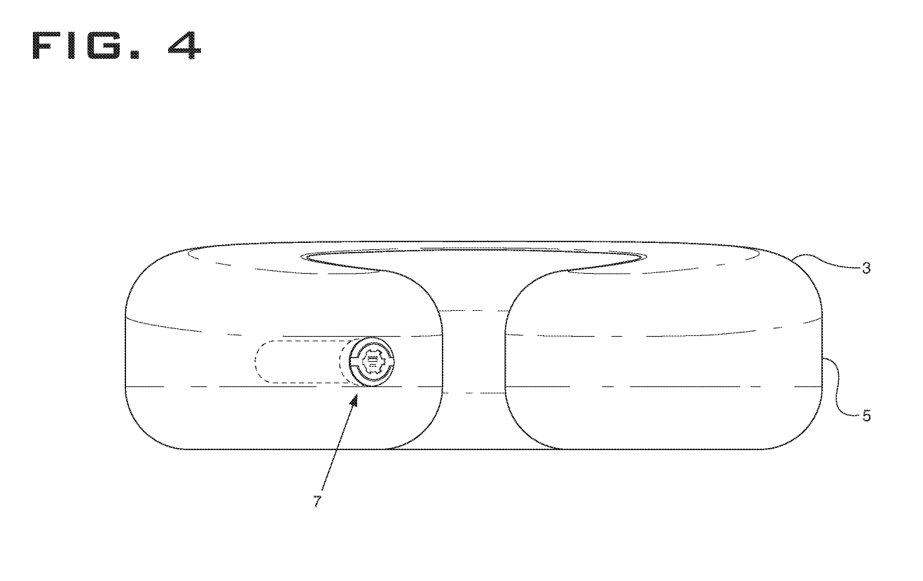

A portable, charging travel pillow, according to the present invention, is shown at 1 in FIG. 1. The portable, charging travel pillow is comprised of a portable pillow body 3, a removable fabric covering 5 and the portable power bank 7. As shown in FIGS. 1-5, the portable pillow body 1 may be a U shaped design wherein the two ends 9 and 11 of the pillow body 3 lie parallel to one another and designed to cradle the sides of a user's neck to provide comfort to the user. Although the pillow body 3 is disclosed and shown as a U shaped design, the pillow body 3 may be any conventional shape, including square, rectangular, elliptical, circular, round, oval or any conventional shape.

The pillow body 3 may be constructed of polyurethane memory foam. Alternatively, the portable pillow body 3 may be constructed of different materials and textiles such as visco-elastic memory foam, Zoned Dough® memory foam, Dough® memory foam, Tempur-pedic® memory foam, Styrofoam, silicone, gel, gel memory foam, cooling gel, cooling gel memory foam, beads, microbeads, beanbag filler, foam, down feathers, rubber, polyester fiberfill, polyester pellets, latex, cotton, air-filled, wool and others.

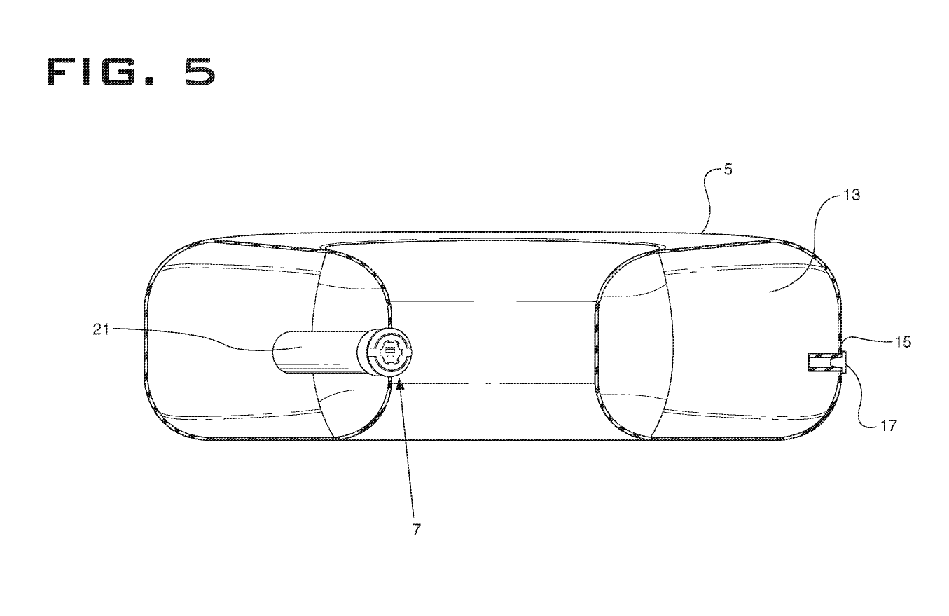

In one embodiment, as shown as FIG. 5, the pillow body 3 may be an inflatable pillow body wherein the pillow body 3 is comprised of a casing or bladder made from an elastomeric material, plastic material, rubber like material or the like. The casing or bladder provides an interior cavity 13 designed to be inflated with air. The casing or bladder of the present embodiment fills the same volume of space the pillow body 3 of FIGS. 1-4 would fill. As with other embodiments, the pillow body 3 may be of any shape, including U-shaped, square, rectangular, elliptical, circular, round, oval or any conventional shape. In the present embodiment, the portable charging pillow 1 possesses a valve, flap, air conduit or opening 15 to provide air to the internal cavity 13 of the casing or bladder of the pillow body 3. The valve, flap, air conduit or opening 15 would allow air to be pumped into the internal cavity 13 to allow the pillow body 3 to be inflated. The valve 15 may possess a closure or sealing member 17 to prevent air from escaping the interior cavity 13 during use of the invention. The valve 15 may allow air to be removed from the interior cavity 13 only when the closure or sealing member 17 is removed and/or when pressure is placed upon the pillow body 3 forcing air to escape from the interior cavity 13 so that the pillow body 3 may be deflated. In one embodiment, the valve 15 may be a one way valve to allow air to be pumped into the internal cavity 13 and prevent backflow of air out of the interior cavity 13. The ability to deflate the pillow body 3 in the present invention allows the portable charging pillow 1 to be easily stored or transported.

In the present invention, as shown in FIGS. 1-5, the pillow body 3 is covered by the removable fabric covering 5. The removable fabric covering 5 comprises at least one fabric member that wraps around the pillow body 3 wherein the edges of the at least one fabric member meet to be fastened together via fastening means (not shown). The removable fabric covering 5 may be constructed of a washable, woven or knitted material. Materials suitable for removable fabric covering include man-made fibers, natural fibers, and combinations thereof, further including cottons, poly/cottons, fleeces, wools, flannels, etc. In the present invention, the fastening means for the removal fabric covering 5 may be a zipper closure, a hook and loop fastener, buttons, snap closures, clasps or any other conventional fastening means. In a preferred embodiment, a portion of the edges of the at least one fabric member may be sewn together wrapping around the pillow body 3 and at least a portion of the edges meet to be fastened together via fastening means. The fastening means allow the user to remove the removable fabric covering 5 from the pillow body 3 to allow the user to clean or freshen the removable fabric covering 5.

In one embodiment, the removable fabric covering may have a handle or grip so that the user can easily carry the present invention. In another embodiment, the removable fabric covering may provide a hood that is fastened to the periphery of the portable charging pillow 1 to allow the user to cover his or head during use of the invention.

In the present invention, as shown in FIGS. 1-3, the portable power bank 7 may be arranged anywhere along the pillow body 3. In a preferred embodiment, the portable power bank 7 is placed within a housing 19 having a cylindrical body 21 and an aperture to allow the user to insert or remove the portable power bank 7. The housing 19 may further possess closure or fastening means at the aperture end of the housing 19 to allow the user to secure the portable power bank 7 in the housing 19 and also allow the user to remove the portable power bank 7 from the housing 19 for use as an individual portable power bank. In one embodiment, the housing 19 possesses fastener tabs to allow the portable power bank 7 to be removable and replaceable.

In the present invention, the housing 19 may be located anywhere along the pillow body 3 as long as the cylindrical body 21 of the portable power bank 7 is contained within the removable fabric covering 5. As shown in the figures, the pillow body 3 may surround the cylindrical body of the housing 19 of the portable power bank 7 for a secure fit.

In one embodiment, as shown in FIGS. 1-5, the housing 19 and portable power bank 7 may be located at one end of the pillow body 3. It will be appreciated by anyone of ordinary skill in the art that the housing 19 and portable power bank 7 may be removably fastened anywhere within the portable charging pillow 1.

The housing 19 may be custom molded into the pillow body 3. The custom molded housing 19 is intended to house the portable power bank 7 and keep the portable power bank 7 in place but also allows for easy removal from the portable charging pillow 1. This allows the portable power bank 7 to be removable and provides the option to the user of either utilizing the portable power bank 7 in conjunction with the portable charging pillow 1 or alternatively as a stand alone portable power bank 7.

In one embodiment of the present invention, the portable power bank 7 operates to output electric energy to a portable handheld mobile device using Universal Serial Bus (USB) power as well as being able to receive electric energy via micro Universal Serial Bus (micro-USB) power. The portable power bank 7 provides a USB port to charge mobile USB powered devices and the microUSB port to charge the portable, charging travel pillow 1.

The portable power bank 7 is a device that can supply USB power using stored energy in its built-in batteries. Other portable power banks usually re-charge with USB power. The portable power bank's 3 specifications are ideally measured in mAh: amount of mA×time at 5V with an external 5V Type-A USB Output Only port and an internal 5V microUSB (Micro-USB) Input only port for storing electric energy and then using it later to charge up a handheld mobile device. Portable power banks are used to charge any USB-charged or USB-powered device such as mobile phones, wireless gaming controllers, cameras, GoPros, portable speakers, GPS systems, MP3 players, smartphones and tablets. The portable power bank 4 may include a casing, a printed circuit board disposed in the casing, a rechargeable battery disposed in the casing and electrically connected to the printed circuit board, a curly transmission wire, and an adapter tip. The curly transmission wire has a first adapting end, and a fixing end passing through the casing and. electrically connecting to the rechargeable battery via the printed circuit board. The adapter tip has a second adapting end connecting to the first adapting end, and a coupling end for electrically connecting to the portable electronic device. It will be appreciated by those of ordinary skill in the art that the portable, charging, travel pillow can be embodied in other specific forms without departing from the spirit of its essential character thereof. The presently disclosed embodiments are therefore considered in all respects to be illustrative and not restrictive.

In the present invention, the portable power bank 7 is not limited in shape, size or capacity and can be different sizes, shapes and capacities. The size can range from small to large and shapes can range from square, rectangle, cubed, oval, round, circular, odd-shaped and cylinder-shaped or any other conventional shape. The portable power bank 7 is capable of charging any standard USB powered handheld mobile device and varies from the capacity of 1500 mAh up to 30000 mAh. The portable power bank is also capable of being recharged and maintaining the charge to provide electric charging capability to any standard USB powered outlet. The capacity of the battery may range from 1500 mAh up to 30000 mAh or above or other.

The portable power bank 7 is not limited to be constructed of lithium polymer and may be constructed of different materials such as Lithium-Ion (Li-ion), Lithium-Polymer (Li-Polymer), NIMH battery cells, Ni—Cd battery cells, solar charged power banks, solar panels, Universal Serial Bus (USB-based) chargers and others.

The portable power bank 7 is not limited to being charged via USB power and is not limited to charging handheld mobile devices via USB power. Furthermore, the portable power bank 7 may be charged, re-charged and may charge portable handheld devices via solar power, inductive charging, conductive wireless charging and others.

The present invention may also possess more than one portable power bank 7. The number of portable power banks 7 is not limited and each portable power bank may be located at any location along the pillow body 3 so that one or more mobile devices may be charged at the same time.

Further, each portable power bank 7 may possess a plurality of USB and microUSB ports and/or connectors. The number of ports or connectors on each portable power bank 7 is not limited and may include one or more USB charging ports connectors per portable power bank 7. The type of connector ports on the power bank is also not limited to standard USB and microUSB.

In the present invention, the portable power bank 7 is not limited to being a stationary piece within the portable charging pillow 1 and may be movable within the portable charging pillow 1 or removable.

While possible embodiments of the portable, charging travel pillow 1 have been disclosed, it should be appreciated that alternatives or variations of any type of material, size, shape, capacity, placement and additions used and future types of material, size, shape, capacity, placement and additions used are within the scope of the present invention.

Thus, the portable charging travel pillow 1 of the present invention provides a more convenient and comfortable device to text and view portable handheld mobile devices while simultaneously charging that said portable handheld mobile device.

Although the preceding description contains significant detail, it should not be construed as limiting the scope of the portable, charging, travel pillow but rather as providing illustrations of the preferred and/or alternative embodiments of the portable, charging, travel pillow.

What is claimed is:

1. A portable, charging travel pillow comprising:
a portable pillow body;
a removable fabric cover securely wrapped about said portable pillow body;
at least one removable portable power bank wherein the at least one removable portable bank is arranged within said removable fabric cover and that is also accessible to the user.

2. A portable charging travel pillow according to claim 1, wherein the portable pillow body is U shaped.

3. A portable charging travel pillow according to claim 1, wherein the portable pillow body is rectilinear in shape.

4. A portable charging travel pillow according to claim 1, wherein a removable housing houses the at least one removable power bank and wherein the removable housing has one end that has an aperture such that the at least one removable power bank can be easily inserted and removed from the removable housing.

5. A portable charging travel pillow according to claim 4, wherein the removable housing is arranged with the removable fabric cover securely but allows the housing to be easily removed from removable fabric cover.

6. A portable charging travel pillow according to claim 5, wherein the removable housing is constructed of a molded plastic.

7. A portable charging travel pillow according to claim 5, wherein the removable housing possesses at least one closure or fastening means at the aperture end of the removable housing to secure the portable power bank in the removable housing.

8. A portable, charging travel pillow comprising:
a portable pillow body wherein the portable pillow body possesses a casing providing an interior cavity designed to be inflated with air;
a removable fabric cover securely wrapped about said portable pillow body;
at least one removable portable power bank wherein the at least one removable portable bank is arranged within said removable fabric cover and that is also accessible to the user.

9. A portable charging travel pillow according to claim 1, wherein the portable pillow body is U shaped.

10. A portable charging travel pillow according to claim 1, wherein the portable pillow body is rectilinear in shape.

11. A portable charging travel pillow according to claim 1, wherein a removable housing houses the at least one removable power bank and wherein the removable housing has one end that has an aperture such that the at least one removable power bank can be easily inserted and removed from the removable housing.

12. A portable charging travel pillow according to claim 11, wherein the removable housing is arranged with the removable fabric cover securely but allows the housing to be easily removed from removable fabric cover.

13. A portable charging travel pillow according to claim 12, wherein the removable housing is constructed of a molded plastic.

14. A portable charging travel pillow according to claim 12, wherein the removable housing possesses at least one closure or fastening means at the aperture end of the removable housing to secure the portable power bank in the removable housing.
